(19) United States
(12) Patent Application Publication
(10) Pub. No.: US 2026/0230197 A1
(43) Pub. Date: Aug. 6, 2026

(54) Systems and Methods for Adaptive Receive Path Loss Compensation in Broadband Satellite Terminals

(71) Applicant: Safran Passenger Innovations, LLC, Brea, CA (US)

(72) Inventors: Nitin Singh Makhloga, Wessling (DE); Tinku Rasheed, Wessling (DE); Oliver Luecke, Wessling (DE)

(73) Assignee: Safran Passenger Innovations, LLC, Brea, CA (US)

(21) Appl. No.: 19/167,745

(22) PCT Filed: Jun. 1, 2023
(86) PCT No.: PCT/US2023/024178

§ 371 Date: Sep. 22, 2025

(51) Int. Cl. H04B 17/18

(52) U.S. Cl. CPC H04B 17/18

(57) ABSTRACT

Broadband satellite terminals are described that allow for automatic adjustment to a gain of an antenna control unit to ensure a power level of a signal received from an antenna is within the required input power level range of the modem. The gain can be adjusted dynamically as needed to account for changes to the modem utilized by the terminal, changes to the satellite, and other factors.

### FIELD OF THE INVENTION

The field of the invention is Internet connectivity for vehicles, and in particular, enhanced broadband satellite terminals for aircraft.

### BACKGROUND

The following description includes information that may be useful in understanding the present invention. It is not an admission that any of the information provided herein is prior art or relevant to the presently claimed invention, or that any publication specifically or implicitly referenced is prior art.

As the demand for Internet connectivity increases continuously, satellite (broadband) terminals are being installed on more and more aircraft and other vehicles. For reception and transmission of data, a satellite modem is typically required. Different satellite types, include for example, geostationary orbit (GEO) satellites, medium Earth orbit (MEO) satellites, and low Earth orbit (LEO) satellites. Signals received from LEO satellites will be of different power level when compared to signals received from GEO satellites, for example. In addition at receive, signals might need to be attenuated in case of LEO satellites to match a sensitivity level of the modem, and is the opposite in the case of GEO satellites.

Broadband satellite terminals based on ARINC 791 typically utilize a factory fixed gain on the antenna control unit (ACU) in the receive chain, while ensuring that the Intermediate Frequency (IF) input power level provided to the modem of the satellite terminal remains within the minimum and maximum power limits required by the modem's specifications.

Constraining the gain of the ACU to a fixed value can be problematic, in cases where a dynamic gain adaptation would keep the actual IF input power level to the modem in the required range despite receive signal power variations (e.g., if the input power to the modem exceeds the maximum allowable IF power level, reducing the ACU gain dynamically would allow maintaining the input power level below the required maximum). In addition, signals received from LEO satellites generally need less ACU gain to match the modem's sensitivity level and the opposite is true in the case of GEO satellites.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for broadband satellite terminals that allow for dynamic gain adaptation.

### SUMMARY OF THE INVENTION

The inventive subject matter provides apparatus, systems, and methods for Internet connectivity for aircraft that utilize a broadband satellite terminal to communicate via one or more satellites on an aircraft. Although an aircraft is discussed, it is contemplated that the systems and methods described herein could be used in trains, boats, busses, and other vehicles where satellite communication is used.

The terminal is configured to interface with multiple modems that may have different input power level requirements, without requiring a different terminal for each modem.

Contemplated terminals utilize an adaptive method that compensates for IF losses by leveraging an antenna control unit (ACU) and the capabilities of the modem of the broadband satellite terminal, such that the gain of the ACU can be adjusted dynamically and in changing environments.

In some embodiments, the systems and methods can utilize receive path loss compensation (RPC) to provide the adaptive method to dynamically set the gain at the ACU. It is preferred that the receive path loss compensation function can be implemented as software within the modem manager (hereafter mentioned as ModMan) of the modem. The changes to the gain at the ACU may be based on one or more factors including, for example, the modem(s) used (and their different sensitivity levels) and the satellite(s) used such as high-throughput satellites (HTS), LEO satellites, medium earth orbit (MEO) satellites and other GEO satellites with different and/or unstable gain-to-noise-temperature at the antenna). The use of receive path loss compensation advantageously ensures that the receive (RX) communication link remains connected beyond the normal available IF range. In this manner, dynamic adaptation of ACU gain can be utilized to adapt to the changing parameters and the needs of the specific platform based on changes to the modem, changes in the Satellite Service Provider (MSP), cable length, and other factors.

The dynamic adjustment to the ACU gain also increases the robustness of the system, which can help mitigate installation issues (e.g., such as due to loose contacts). The automated gain adjustment can adjust the received signal strength in the receive chain and can address low signal-to-noise ratio (SNR) issues.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates a schematic of one embodiment of a broadband satellite terminal.

FIG. 2 illustrates one example of allowable gain settings of the ACU to meet required modem input power level with the given input signal power variation.

FIG. 3 illustrates a table of one example of a receive link budget with a fixed ACU gain of 9 dB.

FIG. 4 illustrates one example of dynamic gain adaptation by the ACU to compensate for an input signal drop.

FIG. 5 illustrates one example of dynamic gain adaptation by the ACU to compensate for an input signal increase and switching of the modem.

FIG. 6 illustrates a flowchart of one embodiment for utilizing receive path loss compensation to dynamic adjust a gain of the ACU.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

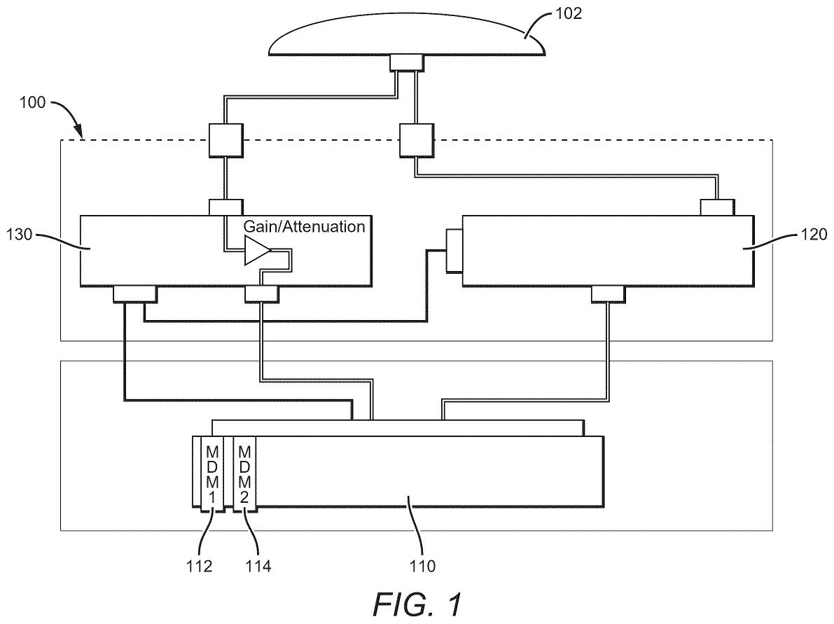

In FIG. 1, a preferred embodiment of a satellite broadband terminal 100 is shown. One or more antennas 102 is communicatively coupled with the terminal 100. Terminal 100 preferably comprises a Ku/Ka Aircraft Networking Data Unit (KANDU) having an ACU 130 which is coupled with a modem manager 110 and a Ku/Ka radio frequency unit (KRFU) having an amplifier 120. In some embodiments, it is contemplated that the amplifier can be externally controlled.

The KANDU controls the antenna 102 by receiving data from the vehicle's navigation or other system(s), which can be used for antenna pointing and tracking and to determine to which satellite to connect, for example. For an aircraft, because the location and altitude of the aircraft vary over time, the unit must change from one satellite to another by reorienting the antenna, acquire a new signal, and establishing a data link, for example.

The modem manager 110 comprises one or more modems, and in this example, comprises a first modem 112 and a second modem 114. Although two modems are shown coupled to the modem manager 110, it is contemplated that a single modem or three or more modems could be coupled to the modem manager 110 without departing from the scope of the invention described herein. The key functionality is the ability to utilize different types of modems and connect with different satellites without having to replace the terminal itself.

Other components of the broadband terminal 100 and/or modem manager may include an electronics package having a main carrier board, at least one processor, memory configured to store one or more software programs, and a power supply. The various components of the terminal 100 are preferably coupled by a wired connection such as Ethernet or coaxial cables, although other suitable wired connections or wireless connections could be used without departing from the scope of the invention herein.

In practice, the terminal 100 receives a signal from the antenna 102 at a specific power level, and the receiver signal power level at the modem interface is defined by the receive chain, which includes constant (e.g., cable losses) and variable contributors. The receive chain may include a configurable but pre-fixed amplification/gain in the ACU to compensate losses and to ensure, as far as possible, that the input power level lies within the required power level range of the modem despite the attenuation and signal power level variations.

It is preferred that the modem manager 110 comprises one or more software routines or algorithms configured such that the modem manager 110 to compensate for the RF (Radio Frequency)/IF (Intermediate Frequency) losses in the receive path of the terminal 100 by adjusting the gain of the ACU 130 dynamically and in changing environments. The gain of the ACU 130 can be adjusted based on one or more factors including, for example, a signal power of the satellite (e.g., due to rain/atmospheric fading,, intra-or inter-system satellite handover, etc.), antenna gain and radome loss, such as due to a dependency on elevation, low noise amplifier blockdown (LNB) converter or simply down converter gain (e.g., due to variation over temperature), adjustment required due to low elevation angles and edge of footprint and affecting antenna gain-to-noise-temperature, humidity on the antenna 102, cable/connector issues, and so forth.

In this manner, the performance of the satellite communication system aboard the vehicle can be optimized and stabilized as needed, while allowing for different modems to be used in a single terminal 100. In other words, the gain at the ACU 130 can be adjusted automatically during operation of the vehicle, while allowing for different modems to be used (and accounting for their different sensitivity levels) and while interfacing with different satellites (e.g., HTS, LEO, MEO and other GEO satellites).

The modem manager 110, by utilizing a receive path loss compensation routine, ensures that the receive (RX) link remains connected beyond the normally available modem input power range.

This approach offers numerous advantages over prior art systems. For example, the dynamic gain adjustment of the ACU 130 by the modem manager 110 allows for seamless calibration of the ACU 130 for any aircraft platform and across changing environments with multiple modems and different satellite providers (e.g., changing MSP and higher/lower gains adjustment). In addition, by allowing one broadband satellite terminal to function with multiple modems and antennas, the overall cost of the system is reduced and specific development costs to support different platforms or modem configuration can be avoided.

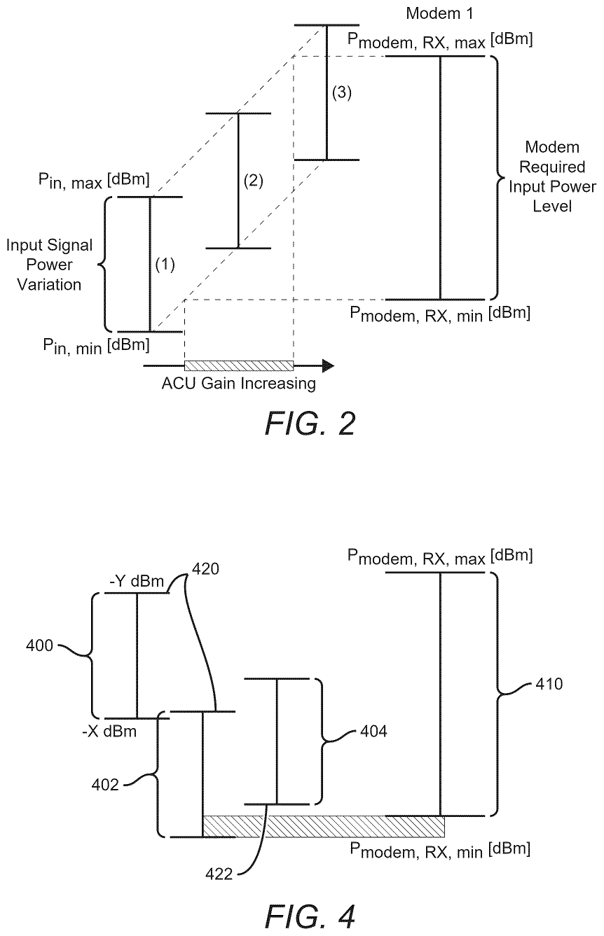

FIG. 2 illustrates an example of allowable ACU gain settings to meet the required modem input power level based on the input signal power variation. Three exemplary ACU gain settings are shown: (1)-(3). The left side shows the input signal power variation at each specific gain setting (i.e., P_{in, min} to P_{in, max}). As the ACU gain increases, the input power also increases.

In this example, the first modem 112 has a required input power level range that falls between P_{modem, RX, min} and P_{modem, RX, max}. Based on the settings of the first modem 112, the first and third settings fall outside of the desired range, and the second setting is acceptable.

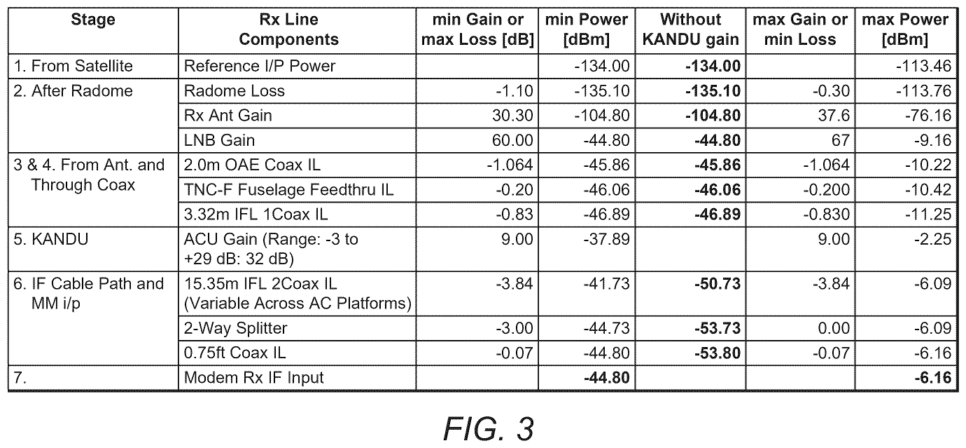

FIG. 3 illustrates one example of a receive link budget with a fixed ACU gain of 9 dB. The minimum modem and maximum modem input power is shown. The power levels at various stages are shown, and the gain adjustment can be seen. The goal is to keep 9 dB at the modem input by varying the gain at the ACU. In addition, the system can utilize the range allowed by the modem to thereby achieve a minimum sensitivity level.

FIG. 4 illustrates an example where the effective input power range/variation falls outside of the required input power range 410 of the modem (i.e., P_{modem, RX, min} to P_{modem, RX, max}). Because the effective input power variation is at least partially outside the required input power range 410 of the modem, a fixed ACU gain is insufficient, and the (combined) input power variations need to be compensated by dynamic control of the ACU gain to ensure correct system performance.

An initial input power range 400 is shown based on a first ACU gain setting 420, which falls within the required input power range 410 of the modem. As shown, the input power range drops to a new range 402 while based on the first ACU gain setting 420. This drop may be due to a satellite hand-over, cable issue, or another factor.

Because the new range 402 falls partially below the required input power range 410 of the modem, the modem manager can be utilized to control and adjust the ACU gain to compensate for the power drop. By automatically adjusting the ACU gain from the first setting 420 to a second setting 422, the input power range is adjusted to a revised range 404 and will again reside within the minimum and maximum values of the modem.

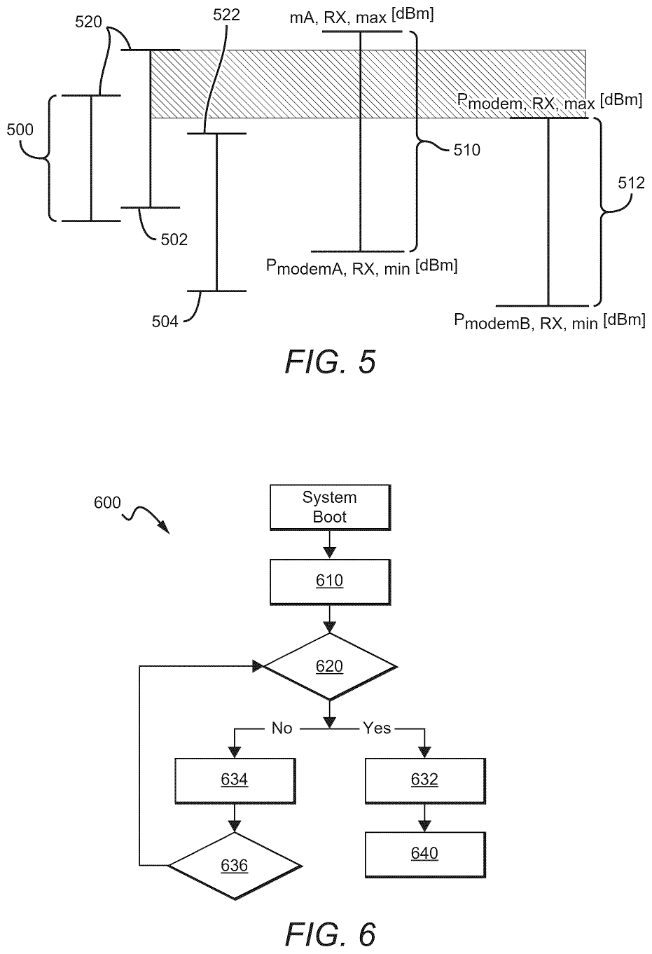

FIG. 5 illustrates another example where the effective input power range/variation may vary from an initial input power range 500 to a second power range 502, based on a first ACU gain setting 520. As shown, both ranges 500, 502 fall within the required input power range 510 of modem A (i.e., P_{modemA, RX, min} to P_{modemA, RX, max}).

In this example, the modem is switched and the new modem B increases to a different required input power range 512 (i.e., P_{modemB, RX, min} to P_{modemB, RX, max}). As a result, both ranges 500, 502 fall outside of the required input power range 512 of modem B. Because the effective input power variation is partially outside the required input power range 512 of the modem, a fixed ACU gain is again insufficient, and the (combined) input power variations need to be compensated by dynamic control of the ACU gain to ensure correct system performance.

Because range 502 falls partially above the required input power range 512 of modem B, the modem manager can be utilized to control and adjust the ACU gain. By automatically adjusting the ACU gain from the first setting 520 to a second setting 522, the input power range is adjusted to a revised range 504 and will again reside within the minimum and maximum values of the modem B.

FIG. 6 illustrates one embodiment of a method 600 for automatically adjusting a gain of the ACU to ensure the power range falls within the required range of the modem.

In Step 610, a RX signal is received at the modem. In Step 620, the signal strength is analyzed. If the signal is within the required power range of the modem, no further optimization is required at Step 632. The modem receives the input signal at Step 640.

If the signal is outside of the required power range of the modem, the modem manager calculates an adjustment to the ACU gain in Step 634 using a SW function or other algorithm.

The gain can then be automatically adjusted at the ACU in Step 636. It is contemplated that the adjustment to the ACU gain can be calculated based on the link budget residing in the software module inside the modem manager, which can utilize the modem's extended IF range to allow the terminal stay online for that extended IF range.

Once adjusted, the new signal strength is analyzed in Step 620, and the process repeats until the signal is within the required power range of the modem.

In some embodiments, it is contemplated that the signal strength (RSSI) can be read continuously and the ACU gain adjusted dynamically using the steps described above. In other embodiments, it is contemplated that the ACU gain could be automatically adjusted based on a set formula. As one example, for every 10° elevation depreciation (loss), the ACU Gain could be adjusted in precalculated steps (e.g., 2 dB) to ensure the signal power falls within the required range of the modem.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, the terms “component”, “module”, “system”, and so forth refer to a computer-related entity, hardware, firmware, software, and a combination of the software and the hardware, or execution of the software. For example, a component may be a processing procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

Those skilled in the art will recognize that logical blocks, configurations, modules, circuits, means, logic, and algorithm steps described in connection with the inventive subject matter disclosed herein may be additionally implemented as electronic hardware, computer software, or combinations thereof. To clearly illustrate the interchangeability of hardware and software, various illustrative components, blocks, configurations, means, logic, modules, circuits, and steps may be described above generally in terms of their functionalities. Whether the functionalities are implemented as the hardware or software depends on a specific application and design restrictions given to an entire system.

Embodiments of the inventive subject matter discussed herein may include or utilize a special purpose or general-purpose computer that includes one or more servers and/or other computer hardware. The one or more servers can each include, for example, one or more processors and system memory. The computer can also include physical and other computer-readable media for carrying or storing computer-executable instructions and/or data structures.

Such instructions can facilitate the systems and methods described and may be stored in a non-transitory computer-readable medium and executable by the one or more servers or other computing devices. As an example, a processor may receive instructions from a non-transitory computer-readable medium and execute those instructions to perform one or more processes.

Computer-readable media can be any available media that can be accessed by a general purpose or special purpose computer system. Examples of computer-readable media include RAM, ROM, EEPROM, solid state drives, flash memory, and other optical disk storage, magnetic disk storage or other magnetic storage devices, or any other medium which can be used to store desired application code in the form of computer-executable instructions or data structures, and which can be accessed by a general purpose or special purpose computer.

Computer-executable instructions include, for example, instructions and data which, when executed at a processor, cause a general-purpose computer, special purpose computer, or special purpose processing device to perform a certain function or group of functions. In some embodiments, computer-executable instructions are executed on a general-purpose computer to tum the general-purpose computer into a special purpose computer implementing elements of the disclosure. The computer executable instructions may be, for example, binaries, intermediate format instructions such as assembly language, or even source code.

The systems and methods described herein may utilize various communication protocols including, for example, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A satellite broadband terminal installed within a vehicle, comprising:
a networking data unit comprising an antenna control unit (ACU), and configured to receive a signal from an antenna of the vehicle;
a radio frequency unit comprising an amplifier; and
a modem manager configured to receive a first modem having a first required input power level range;
wherein the modem manager, networking data unit and radio frequency unit are communicatively coupled;
wherein the modem manager is configured to analyze the signal received from the antenna and automatically calculates an adjustment to a gain of the ACU if the power level of the signal is outside of the first required input power level range; and
wherein the modem manager resets the gain of the ACU based on the calculated adjustment such that the power level of the signal is within the first required input power level range.

2. The satellite broadband terminal of claim 1, wherein the modem manager is further configured to receive a second modem having a second required input power level range.

3. The satellite broadband terminal of claim 2, wherein the modem manager is configured to switch from the first modem to the second modem, and wherein the modem manager is configured to analyze the signal received from the antenna and automatically calculates the adjustment to the gain of the ACU if the power level of the signal is outside of the second required input power level range of the second modem.

4. The satellite broadband terminal of claim 3, wherein the modem manager resets the gain of the ACU based on the calculated adjustment such that the power level of the signal is within the second required input power level range.

5. The satellite broadband terminal of claim 2, wherein the first and second modems are different types.

6. The satellite broadband terminal of claim 1, wherein the amplifier is externally controlled.

7. The satellite broadband terminal of claim 1, wherein the terminal receives the signal at a specific power level and wherein the ACU gain is defined by a receive chain.

8. The satellite broadband terminal of claim 1, wherein the modem manager calculates the adjustment to the gain of the ACU based on at least one of the following factors: a signal power of the satellite, an antenna gain, a radome loss, down converter gain, an elevation angle, and humidity on the antenna.

9. The satellite broadband terminal of claim 1, wherein the modem manager comprises at least one processor and a computer program stored in a non-transitory computer-readable storage medium, wherein the computer program executes the following operations for calculating an adjustment to the gain of the ACU when the computer program is executed by the at least one processor, the operations comprising:
an operation of receiving a signal;
an operation of analyzing a power level of the received signal; and
an operation of calculating an adjustment to the gain of the ACU if the power level of the signal is outside of the first required input power level range, wherein the adjustment to the gain of the ACU is calculated based on a link budget residing in the modem manager.

10. A method for maintaining a power level of a received satellite signal in a broadband satellite terminal within a predefined power level range using a computing device including at least one processor, the method comprising:
receiving a signal from an antenna of a satellite via an antenna control unit (ACU) of the broadband satellite terminal;
analyzing a power level of the received signal by comparing the power level with a required input power level range of a modem disposed to receive the signal;
if the power level of the signal is partially or fully outside of the required input power level range, (i) calculating an adjustment to a gain of the ACU and (ii) automatically setting the gain of the ACU to a new value based on the calculated adjustment.

11. The method of claim 10, wherein the adjustment to the gain of the ACU is calculated based on a link budget residing in a modem manager of the broadband satellite terminal.

12. The method of claim 10, wherein the adjustment to the gain of the ACU is based on a signal power of the satellite, an antenna gain, a radome loss, down converter gain, an elevation angle, and humidity on the antenna.

13. The method of claim 10, further comprising:
switching from the modem to a second modem;
analyzing the power level of the received signal by comparing the power level with a required input power level range of the second modem; and
if the power level of the signal is partially or fully outside of the required input power level range of the second modem, (i) calculating an adjustment to a gain of the ACU and (ii) automatically setting the gain of the ACU to the new value based on the calculated adjustment.

14. The method of claim 13, wherein the required input power level range of the second modem is different from the required input power level range of the modem.

15. The method of claim 13, wherein the modem and the second modem are different types.

16. The method of claim 13, wherein the broadband terminal further comprises an amplifier, and wherein the modem manager, ACU, and amplifier are communicatively coupled.

17. The method of claim 16, wherein the amplifier is externally controlled.

18. The method of claim 10, wherein the signal is received at a specific power level and wherein the gain of the ACU is defined by a receive chain.
